(19) United States
(12) Patent Application Publication
(10) Pub. No.: US 2021/0181373 A1
(43) Pub. Date: Jun. 17, 2021

(54) Fast Realizations from Geostatistical Simulations

(71) Applicant: C Tech Development Corporation, Sarasota, FL (US)

(72) Inventors: Reed Dennis Copsey, JR., Yarmouth, MD (US); Bengt Rosenberger, Berlin (DE); Reed Dennis Copsey, Sarasota, FL (US)

(21) Appl. No.: 16/716,041

(22) Filed: Dec. 16, 2019

(51) Int. Cl. G01V 99/00; G06F 30/20

(52) U.S. Cl. CPC G01V 99/005; G06F 2111/10; G06F 30/20

(57) ABSTRACT

Geostatistical realizations are generated based on estimates, which are based on measurements for which one can compute corresponding variances. A shift field is generated by generating random values, which may be constrained according to a confidence restraint. A value of the shift field is applied to a standard deviation for an estimate calculated based on the corresponding variance for that estimate. The random values may be generated according to a gradient noise algorithm taking as an input a wavelength defining smoothness of an array of random values. The wavelength is decoupled from a grid spacing of the estimated values.

### BACKGROUND

In order to characterize physical phenomena such as migration of chemicals or composition of rock beneath the earth's surface, geostatistical simulation may be performed. This approach generally includes an estimation between measured values of properties at various locations and depths in combination with added randomized statistical variations to obtain a “realization.” The estimations may be performed using numerical methods to compute both interpolations and extrapolations of measured values onto a 2D or 3D grid. The realization is an array of estimates for a grid of locations in a region including the measured locations and depths, the estimates indicating likely chemical concentrations or rock composition throughout the region.

In prior approaches, this process is extremely computationally expensive. Accordingly, it would be an advancement in the art to improve the speed at which realizations can be generated.

### BRIEF DESCRIPTION OF THE FIGURES

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of components for generating fast geostatistical realizations in accordance with an embodiment of the present invention;

FIG. 2 is a process flow diagram of a method for generating fast realizations in accordance with an embodiment of the present invention;

FIG. 3A is an estimation of values throughout a region based on measured values;

FIG. 3B is a realization based on the estimation of FIG. 3A in accordance with an embodiment of the present invention;

FIG. 3C is a realization based on the estimation of FIG. 3A in accordance with an embodiment of the present invention;

FIG. 4A is an estimation of chemical concentration values throughout a region based on measured values.

FIGS. 4B and 4C are realizations based on the estimation of FIG. 4A in accordance with an embodiment of the present invention;

FIG. 5A is an estimation of rock types throughout a region based on measured values;

FIG. 5B is a realization based on the estimation of FIG. 5A in accordance with an embodiment of the present invention; and

FIG. 6 is a schematic block diagram of a computer system suitable for implementing methods in accordance with embodiments of the present invention.

### DETAILED DESCRIPTION

It will be readily understood that the components of the invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the invention may be embodied as an apparatus, method, or computer program product. Accordingly, the invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the invention may be written in any combination of one or more programming languages, including an object-oriented programming language such as Java, Smalltalk, C++, or the like and conventional procedural programming languages, such as the “C” programming language or similar programming languages, and may also use descriptive or markup languages such as HTML, XML, JSON, and the like. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

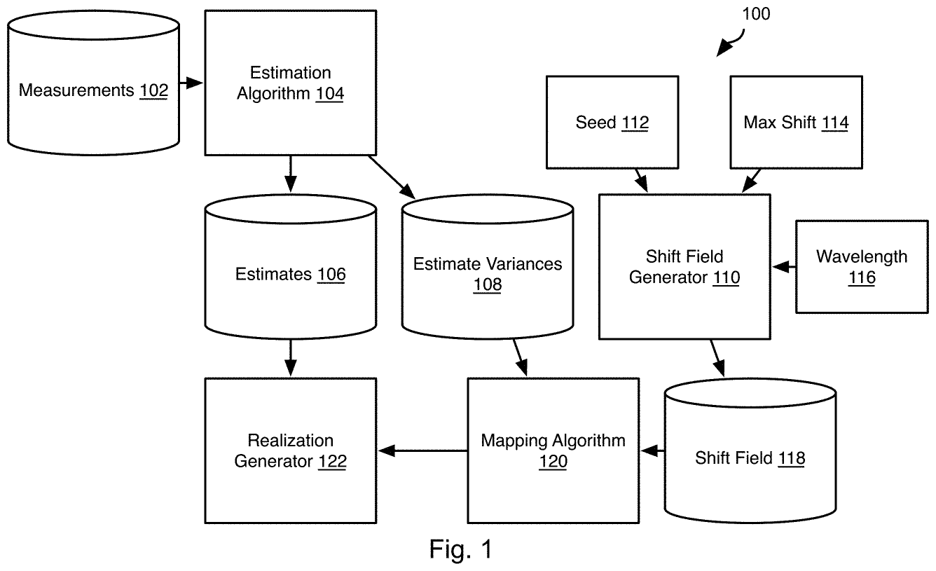

Referring to FIG. 1, the illustrated system 100 may be used to generate realizations of estimates of physical properties in a two-dimensional (2D) or three-dimensional (3D) region based on measurements within that region. The system 100 may take as an input measurements 102. The measurements 102 may be a series of entries in which each entry is a measurement of one or more physical properties in a region space and either (a) is tagged with a 2D or 3D location at which the measurement was taken or (b) stored at a location in an array that can be related to a 2D or 3D location in the region by scaling a 2D or 3D index of the location in the array. Various examples of types of measurements are discussed below. Any physical property may be measured, particularly concentration of a chemical, physical composition (type of rock, soil, etc.), or other physical property.

The measurements may be input to an estimation algorithm 104. The estimation algorithm computes values for the measured physical property throughout the region based on the measured values and their locations. Any estimation algorithm known in the art may be used. For example, kriging is particularly effective. Another example is the natural neighbor estimation algorithm.

The result of the estimation 104 is an array of estimated values 106, a 2D array where measurements have 2D positions and a 3D array where measurements have 3D positions. The array may have a defined grid spacing that relates a 2D or 3D index within the array to a 2D or 3D position, respectively, within and potentially beyond the general region in which the measurements were taken. Likewise, an offset in each dimension (X, Y, Z) may facilitate defining the physical location corresponding to each grid location. For example, i*dX+X0 may give the X dimension location for index i in the array, where dX is the grid spacing in the X dimension and X0 is an offset in the X direction. The spacing in a given dimension may be different from that in a different dimension. For example, in X and Y dimensions in a horizontal plane, the spacing between adjacent grid positions may be dX. The grid spacing in the Z dimension may be dZ, where dZ is smaller than dX.

Another output of the estimation algorithm 104 may be a qualifier for each value in the array of estimates. Where the estimation algorithm 104 is kriging, the qualifier for each estimate is a variance 108, where the variance generally increases with distance and directions of the point to be computed from the locations of adjacent measurements. For the natural neighbor algorithm the qualifier is a variance computed with the interpolation weights of all neighboring data points.

The system 100 may further include a shift field generator 110. The shift field generator 110 may take as inputs a random seed 112, a maximum shift 114, and a wavelength 116. The shift field generator 110 generates an array of random values (shift field 118) that may be superimposed on the array of estimates 106, e.g., the array indexes of the shift field 118 correspond to array indexes of the estimates 106. The operation of the shift field generator 110 is described in greater detail below.

A mapping algorithm 120 takes as inputs the variances and the shift field 118 and generates, for each estimate, a final shift amount that is added to the estimate by the realization generator 122 to obtain a realization, the final shift amount being a function of the value of the shift field 118 and variances 108 having the same array location as the each estimate. The manner in which this combination is performed is described below.

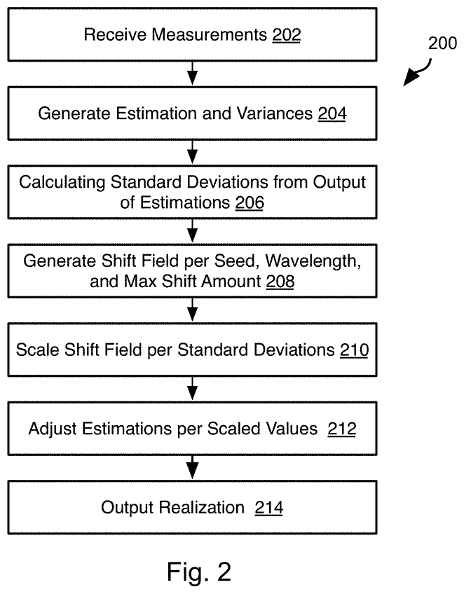

Referring to FIG. 2, the system 100 may be used to implement the illustrated method 200. The method 200 includes receiving 202 the measurements 102 and their associated locations and generating 204 kriging estimates for a 2D or 3D region including the locations of the measurements. As noted above, step 204 may include using the natural neighbor algorithm to obtain the estimates. The result of step 204 is the estimates 106 comprising a 2D or 3D array of estimates with each estimate corresponding to a physical location defined by its index within the array. Another result of step 204 is an array of variances, each variance in the array corresponding to an estimate in the array of estimates having the same combination of indexes, e.g. E(i,j,k) corresponds to V(i,j,k), where E is the array of estimates, V is the array of variances, and i, j, and k are index values.

The method 200 may include calculating 206 standard deviations from the variances obtained at step 204, e.g., S(i,j,k)=f(V(i,j,k). In particular, step 206 calculates a standard deviation of a normal Gaussian distribution corresponding to the variance. In some embodiments, this may include calculating S(i,j,k) as the square root of V(i,j,k). Where the estimation algorithm 104 is the natural neighbor algorithm, a similar approach may be used where the weight corresponding to an estimate is a variance computed with the interpolation weights of all neighboring data points.

The method 200 may further include generating 208 a shift field 118 for the estimates, e.g. an array of shift values F(i,j,k) that each correspond to a value in the array of estimates E(i,j,k) with the same indexes. The shift field may be generated as a function of a random seed 112, a maximum shift amount 114, and a wavelength 116. The shift field generator 110 may implement a pseudo random process in which all values are a function of an initial random seed 112. In this manner, where the same seed 112 is used the same random values will be generated, which may be helpful with debugging. Where a truly random set of values is desired, the seed 112 may be randomly generated. The maximum shift amount 114 specifies bounds on the magnitude of random values that may be used to specify a degree of confidence that the values in a final realization correspond to a possible real-world scenario.

The wavelength 116 specifies a degree of smoothness among adjacent values in the array of values in the shift field. For example, a gradient noise algorithm as known in the art may be used and the wavelength 116 is an input parameter to that algorithm that specifies smoothness: the larger the wavelength, the smaller the variation between adjacent values (e.g., F(i,j,k) and F(i+1,j,k)) in the shift field 118.

As is apparent in FIG. 1 and the description of the method 200, the shift field 118 is generated independently of the estimates 106. In this manner, the wavelength 116 may be controlled independently of the generation of the estimates 106. This is advantageous in modeling real world scenarios. A high density of estimates may be generated but the noise used to generate the realization can be at a wavelength larger than the grid spacing, which may be controlled to more accurately model real-world processes, such as chemical diffusion or geologic properties, that will not likely be subject to a large amount of local variation on the order of the grid spacing.

The values of the shift field 118 may be generated as follows:
1. A random number generator that provides a normal Gaussian distribution of outputs is initialized with the random seed 112.
2. A standard deviation of the distribution may be set based on the maximum shift amount 114. For example, let S1 be a number of standard deviations corresponding to the maximum shift amount 114. The maximum shift amount 114 may be specified as a confidence value (a value M between 0 and 1 or between 50 and 100 percent). This may be related to S1: a number of standard deviations S1 of a normal Gaussian distribution such that a ratio of the number of values between −S1 and +S1 relative to all values in the distribution will be M. The standard deviation S2 of the random number generator may therefore be set such that a value S1*S2 will be 1 and a value of −S1*S2 will be −1, e.g. S2=1/S1. Alternatively, outputs of the random number generator may be scaled after generation, R1=R0/(S2*S1), where R0 is the output of the random number generator and R1 is the scaled value.
3. A set of random numbers is generated equal to the number of estimates in the array of estimates 106. Random numbers with a magnitude greater than 1 or −1 are discarded and random numbers continue to be generated until the number of random numbers that has not been discarded is equal to the number of estimates in the array of estimates 106. As noted above, random numbers may be generated using a gradient noise algorithm such that a location within the array is taken into account when generating a random value based on the wavelength. Note further that different wavelengths 116 may be specified for different dimensions (X, Y, Z) and implemented by the gradient noise algorithm such that the smoothness of the random values is anisotropic. For example, one common scenario is that the wavelength in the vertical Z direction is different that the wavelength in the X and Y directions, i.e. horizontal directions.

The shift field 118 may then be applied 210 to the standard deviations from step 206 by a mapping algorithm 120. For example, a given shift field value F(i,j,k) may be multiplied by its corresponding standard deviation S(i,j,k) to obtain a scaled value SF(i,j,k). The scaled value is random according to generation of the shift field but also has a magnitude that takes into account the uncertainty in the estimation used to generate the estimates. However, this randomness is generated after generation of the estimates and the values of the estimates in the array of estimates 106 is independent of the scaled values.

In this manner, different shift fields 118 and scaled values may be generated for the same estimates. For example, a user may run the method 200 repeatedly with different random seeds 112 in order to quickly generate multiple shift fields and corresponding realizations. The shift fields 118 according to the system and method described above may have wavelengths independent of the grid spacing of the estimates. The calculating of each scaled value and its application to a corresponding estimate of the array of estimates 106 is independent of other scaled values such that these steps may be performed in parallel. Note further that since the random value is scaled by the standard deviations, array values corresponding to locations at or near actual measurement locations will be scaled by a small amount or not scaled at all since the variances and hence the standard deviations will be near or at zero at the measurement locations.

The estimates of the array of estimated values may then be adjusted 212 according to the scaled values from step 210, e.g. R(i,j,k)=E(i,j,k)+SF(i,j,k), where R(I,j,k) is the realization generated based on the scaled values SF(i,j,k). The realization R may then be output 214, such as by storage in a persistent storage device. Step 214 may further include rendering a visualization of the realization R.

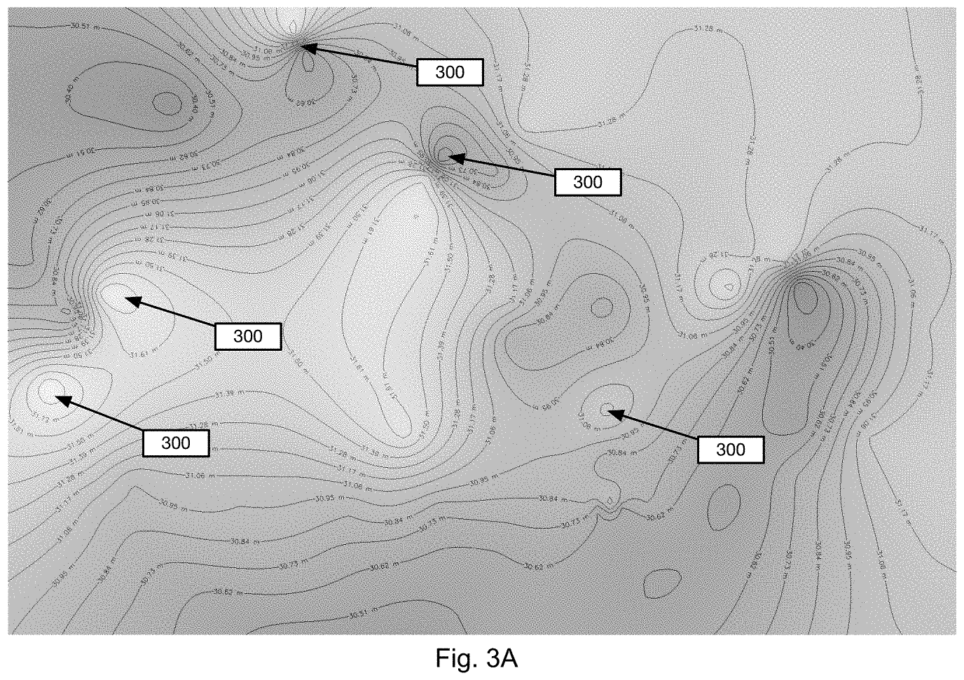

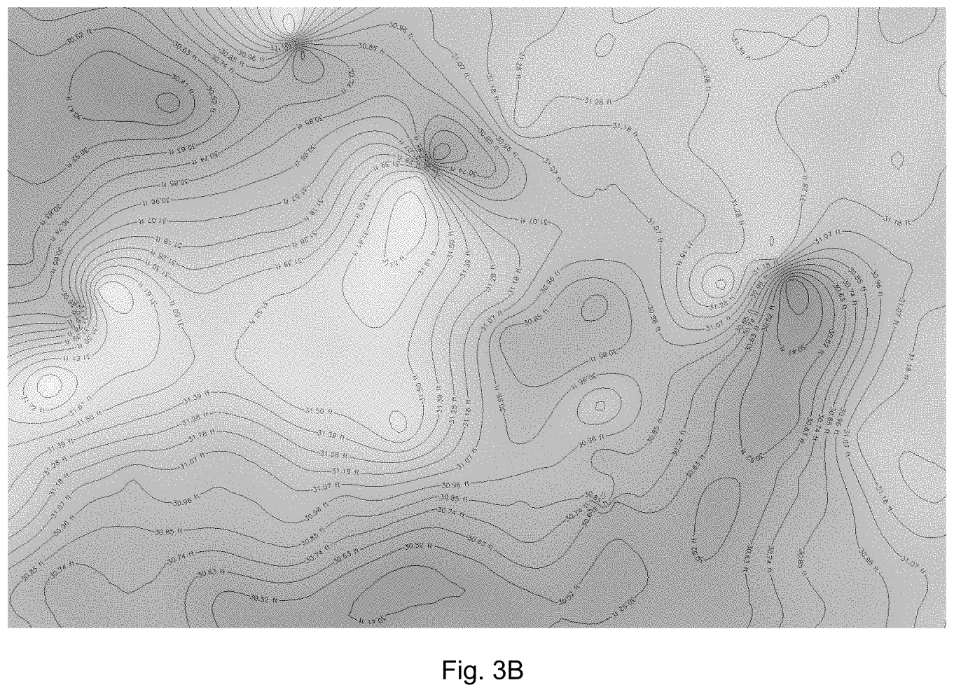

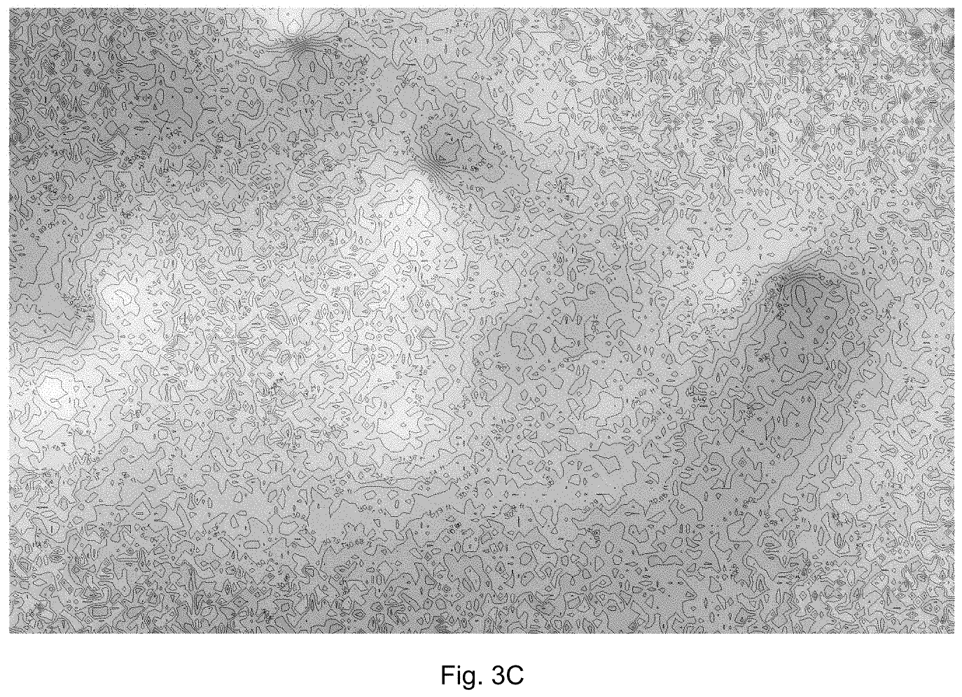

FIGS. 3A to 5B illustrate example applications of the system 100 and method 200. FIG. 3A illustrates a 2D estimation among measured points 300, such as might be the result of step 204. For example, FIG. 3A may represent a 3D stratigraphic modeling of subsurface geology performed by creating surfaces which correspond to stratigraphic horizons. The system 100 and method 200 may also be applied to 2D surfaces that have 3D elevations.

The intensity at each point may represent any physical quantity, such as chemical concentration, elevation, or the like. FIG. 3B illustrates a realization based on the estimation in FIG. 3A in which noise has been added according to the method 200 in order to illustrate a possible scenario. FIG. 3C illustrates a realization based on the estimation of FIG. 3A but with a shorter wavelength than FIG. 3B. Note that FIG. 3C illustrates what occurs when the wavelength is too small: the realization may show a level of variation that does not conform to physical reality in which spatial variation will be much smoother. FIG. 3D further illustrates the result that might be obtained where the randomness is introduced as part of the estimation process such that the wavelength of noise cannot be independently controlled relative to grid spacing, which is the case in prior approaches.

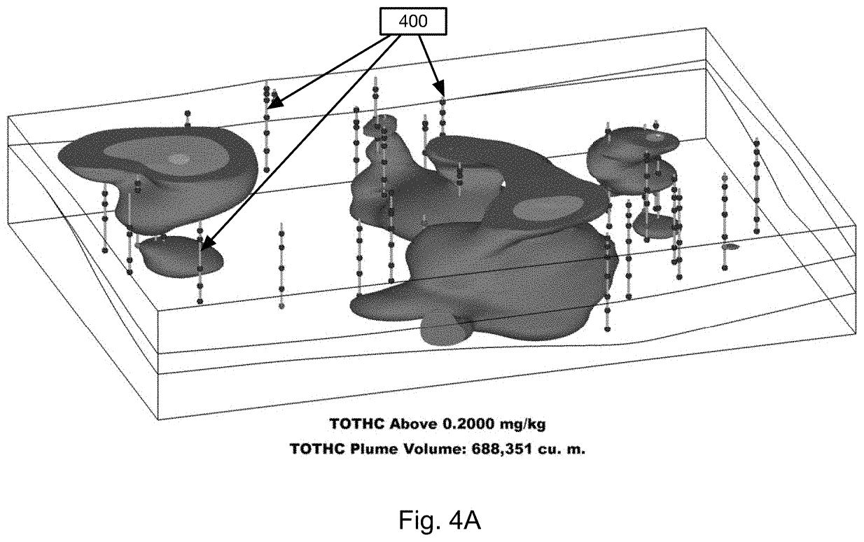

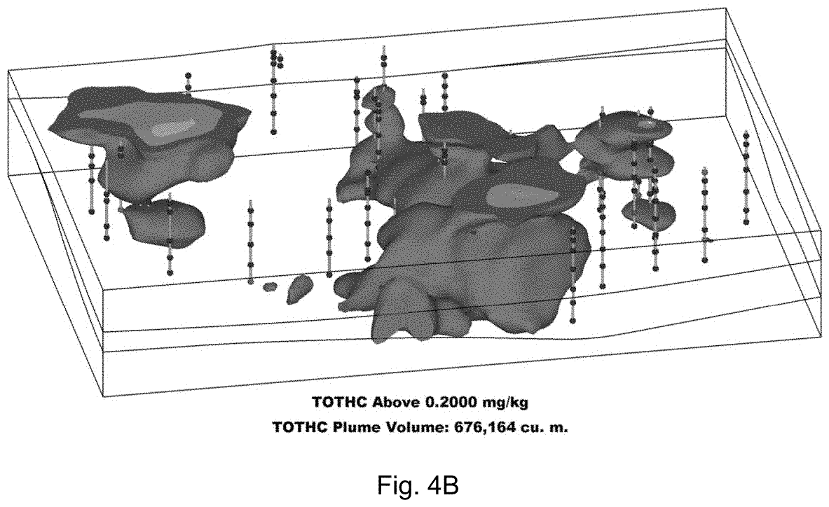

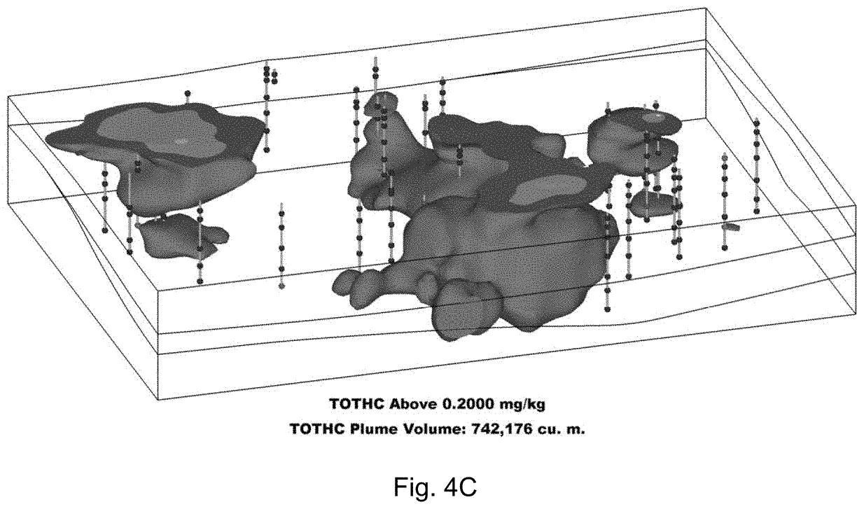

FIG. 4A illustrates 3D estimation of chemical concentration based on columns 400 of measurements. The dots 400 on each column represent measurements taken along that column. For example, FIG. 4A may be the result of analytical modeling of continuum data such as the concentration of soil contaminants or mineral ores, which may be performed using both 2D and 3D models.

FIG. 4B illustrates a realization based on the estimation of FIG. 3A with noise added according to the method 200. FIG. 4C illustrates a realization based on the estimation of FIG. 3A with noise added according to the method 200 using a smaller wavelength than that used for FIG. 4B.

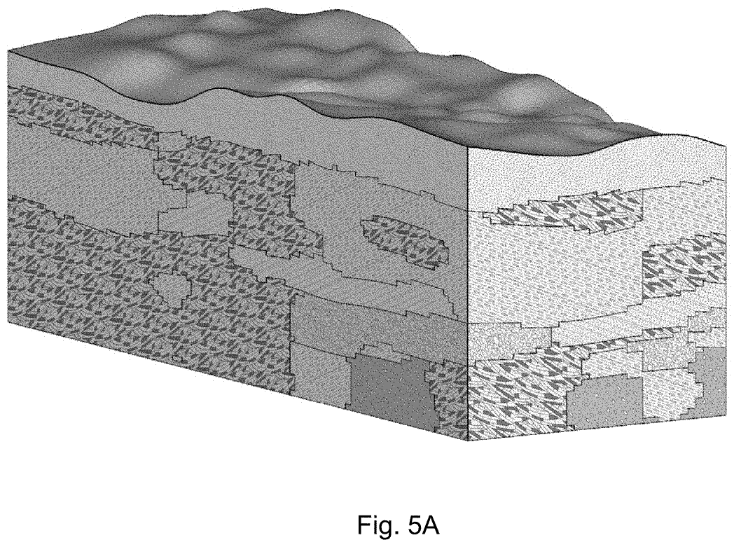

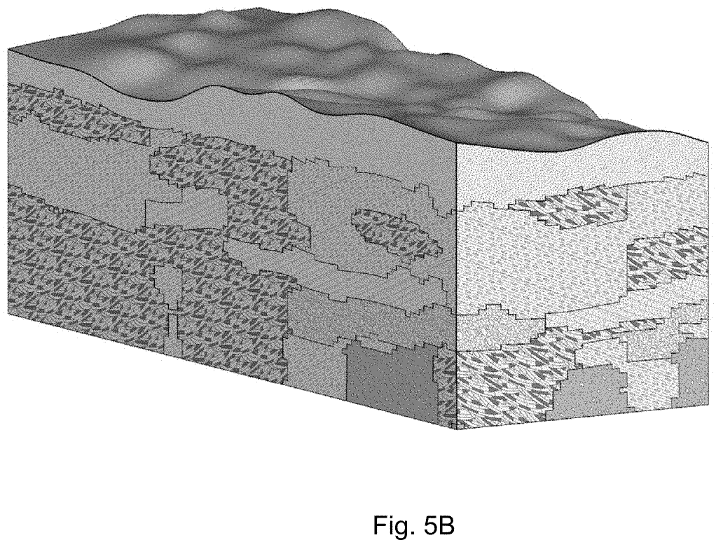

FIG. 5A illustrates an estimation based on measurements of geologic material composition. In particular, the system 100 and method 200 may be applied to 3D lithologic modeling of subsurface geology. In particular, each different fill pattern indicates a different type of material, e.g. soil, water, type of rock, etc. The composition estimate of FIG. 5A may be generated according to conventional techniques. For example, for each type of material, the measurements finding it to be present are analyzed separately to obtain an estimation indicating the likelihood of the material being present at that location. The estimations for each type of material are then compared at each position in the array of estimates. The type of material with the highest value in its estimation at that array position is selected as being the material most likely to be present at the location corresponding to that array position.

FIG. 5B illustrates a realization based on the estimation of FIG. 5A. In this approach, a realization is generated for the estimation for each material type according to the method 200. These realizations are then combined as described above: for each array position, the realization with the highest value means that the material type for that realization will be selected as the material present at that location.

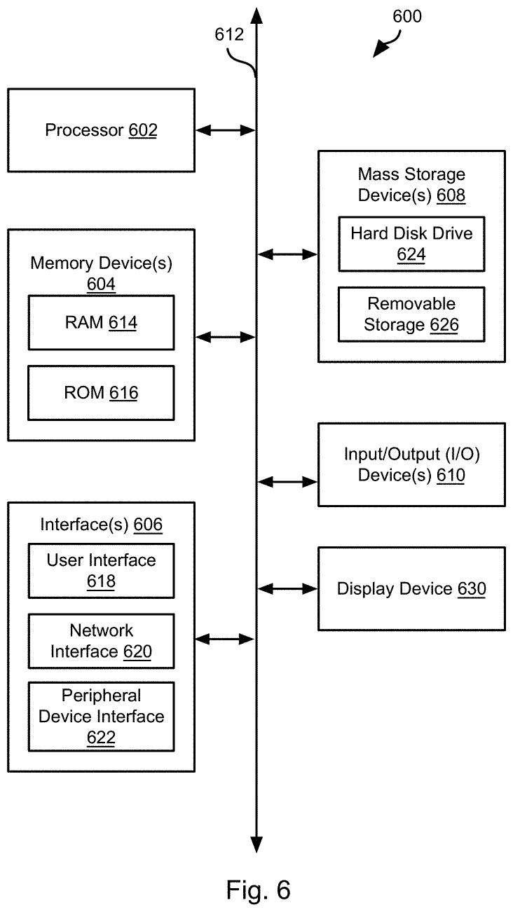

FIG. 6 is a block diagram illustrating an example computing device 600 which can be used to implement the system and methods disclosed herein. In some embodiments, a cluster of computing devices 600 interconnected by a network may be used to implement the invention.

Computing device 600 may be used to perform various procedures, such as those discussed herein. Computing device 600 can function as a server, a client, or any other computing entity. Computing device 600 can execute one or more application programs, such as the application programs described herein. Computing device 600 can be any of a wide variety of computing devices, such as a desktop computer, a notebook computer, a server computer, a handheld computer, tablet computer and the like.

Computing device 600 includes one or more processor(s) 602, one or more memory device(s) 604, one or more interface(s) 606, one or more mass storage device(s) 608, one or more Input/Output (I/O) device(s) 610, and a display device 630 all of which are coupled to a bus 612. Processor(s) 602 include one or more processors or controllers that execute instructions stored in memory device(s) 604 and/or mass storage device(s) 608. Processor(s) 602 may also include various types of computer-readable media, such as cache memory.

Memory device(s) 604 include various computer-readable media, such as volatile memory (e.g., random access memory (RAM) 614) and/or nonvolatile memory (e.g., read-only memory (ROM) 616). Memory device(s) 604 may also include rewritable ROM, such as Flash memory.

Mass storage device(s) 608 include various computer readable media, such as magnetic tapes, magnetic disks, optical disks, solid-state memory (e.g., Flash memory), and so forth. As shown in FIG. 6, a particular mass storage device is a hard disk drive 624. Various drives may also be included in mass storage device(s) 608 to enable reading from and/or writing to the various computer readable media. Mass storage device(s) 608 include removable media 626 and/or non-removable media.

I/O device(s) 610 include various devices that allow data and/or other information to be input to or retrieved from computing device 600. Example I/O device(s) 610 include cursor control devices, keyboards, keypads, microphones, monitors or other display devices, speakers, printers, network interface cards, modems, lenses, CCDs or other image capture devices, and the like.

Display device 630 includes any type of device capable of displaying information to one or more users of computing device 600. Examples of display device 630 include a monitor, display terminal, video projection device, and the like.

Interface(s) 606 include various interfaces that allow computing device 600 to interact with other systems, devices, or computing environments. Example interface(s) 606 include any number of different network interfaces 620, such as interfaces to local area networks (LANs), wide area networks (WANs), wireless networks, and the Internet. Other interface(s) include user interface 618 and peripheral device interface 622. The interface(s) 606 may also include one or more user interface elements 618. The interface(s) 606 may also include one or more peripheral interfaces such as interfaces for printers, pointing devices (mice, track pad, etc.), keyboards, and the like.

Bus 612 allows processor(s) 602, memory device(s) 604, interface(s) 606, mass storage device(s) 608, and I/O device(s) 610 to communicate with one another, as well as other devices or components coupled to bus 612. Bus 612 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 600, and are executed by processor(s) 602. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

1. A method comprising:
receiving, by a computer system, a set of measurements each corresponding to a point in a region;
(a) generating, by the computer system, an array of estimates by applying an estimation algorithm to the set of measurements, each estimate of the array of estimates corresponding to a position within the region and having a qualifier associated therewith;
(b) for each estimate in the array of estimates, generating, by the computer system, a corresponding shift value of an array of shift values according to the qualifier associated with the each estimate;
combining, by the computer system, the array of shift values and the array of estimates to obtain a realization array;
outputting, by the computer system, the realization array; and
wherein generating the array of estimates at (a) is independent of generating the array of shift values at (b).

2. The method of claim 1, wherein the estimation algorithm comprises kriging and the qualifier associated with each estimate of the array of estimates is a variance.

3. The method of claim 1, wherein the estimation algorithm comprises a natural neighbor algorithm and the qualifier associated with each estimate of the array of estimates is a weight.

4. The method of claim 1, wherein the estimation algorithm comprises at least one of an inverse distance weighted estimation and an estimation based on a radial basis function.

5. The method of claim 1, wherein (b) comprises, for each estimate in the array of estimates, generating the corresponding shift value of the array of shift values by:
generating, by the computer system, a random value; and
scaling, by the computer system, the random value by the qualifier associated with the each estimate to obtain the corresponding shift value.

6. The method of claim 1, wherein (b) comprises, for each estimate in the array of estimates, generating the corresponding shift value of the array of shift values by:
generating, by the computer system, a random value according to a gradient noise algorithm; and
scaling, by the computer system, the random value by the qualifier associated with the each estimate to obtain the corresponding shift value.

7. The method of claim 6, further comprising generating the random value according to the gradient noise algorithm subject to a wavelength defining a smoothness in variation of the random value relative to random values generated for estimates of the array of estimates adjacent to the each estimate.

8. The method of claim 7, wherein the wavelength is different from a grid spacing between the positions corresponding to the estimates of the array of estimates.

9. The method of claim 7, wherein the wavelength is larger than a grid spacing between the positions corresponding to the estimates of the array of estimates.

10. The method of claim 1, wherein (b) comprises, for each estimate in the array of estimates, generating the corresponding shift value of the array of shift values by:
generating, by the computer system, a random value satisfying a confidence constraint; and
scaling, by the computer system, the random value by the qualifier associated with the each estimate to obtain the corresponding shift value.

11. The method of claim 10, further comprising:
defining, by the computer system, a standard deviation multiple corresponding to the confidence constraint;
generating, by the computer system, a plurality of random values having a normal distribution with a standard deviation; and
discarding, by the computer system, a first portion of the plurality of random values having a magnitude larger than a standard deviation of the normal distribution multiplied by the standard deviation multiple while retaining a remaining portion of the plurality of random values;
wherein generating, by the computer system, the random value satisfying the confidence constraint comprises selecting the random value from the remaining portion.

12. The method of claim 11, wherein the estimation algorithm comprises kriging and the qualifier associated with each estimate of the array of estimates is a variance, the method further comprising, for each estimate of the array of estimates, obtaining an estimated standard deviation according to the variance associated with the each estimate;
wherein scaling, by the computer system, the random value by the qualifier associated with the each estimate to obtain the corresponding shift value comprises scaling the random value by the estimated standard deviation.

13. A non-transitory computer readable medium storing executable code that, when executed by one or more processing devices, causes the one or more processing devices to:
receive a set of measurements each corresponding to a point in a region;
(a) generate an array of estimates by applying an estimation algorithm to the set of measurements, each estimate of the array of estimates corresponding to a position within the region and having a qualifier associated therewith;
(b) for each estimate in the array of estimates, generate a corresponding shift value of an array of shift values according to the qualifier associated with the each estimate;
combine the array of shift values and the array of estimates to obtain a realization array;
output the realization array; and
wherein generating the array of estimates at (a) is independent of generating the array of shift values at (b).

14. The non-transitory computer readable medium of claim 13, wherein the estimation algorithm comprises kriging and the qualifier associated with each estimate of the array of estimates is a variance.

15. The non-transitory computer readable medium of claim 13, wherein the estimation algorithm comprises one of a natural neighbor algorithm, an inverse distance weighted estimation, and a radial basis function.

16. The non-transitory computer readable medium of claim 13, wherein the executable code, when executed by one or more processing devices, further causes the one or more processing devices to perform (b) by, for each estimate in the array of estimates, generating the corresponding shift value of the array of shift values by:
generating a random value according to a gradient noise algorithm; and
scaling the random value by the qualifier associated with the each estimate to obtain the corresponding shift value.

17. The non-transitory computer readable medium of claim 16, wherein the executable code, when executed by one or more processing devices, further causes the one or more processing devices to:
generate the random value according to the gradient noise algorithm subject to a wavelength defining a smoothness in variation of the random value relative to random values generated for estimates of the array of estimates adjacent to the each estimate.

18. The non-transitory computer readable medium of claim 17, wherein the wavelength is larger than a grid spacing between the positions corresponding to the estimates of the array of estimates.

19. The non-transitory computer readable medium of claim 13, wherein the executable code, when executed by one or more processing devices, further causes the one or more processing devices to perform (b) by, for each estimate in the array of estimates, generating the corresponding shift value of the array of shift values by:
generating a random value satisfying a confidence constraint;
scaling the random value by the qualifier associated with the each estimate to obtain the corresponding shift value.

20. The non-transitory computer readable medium of claim 19, wherein the executable code, when executed by one or more processing devices, further causes the one or more processing devices to:
defining a standard deviation multiple corresponding to the confidence constraint;
generating a plurality of random values having a normal distribution with a standard deviation; and
discarding a first portion of the plurality of random values having a magnitude larger than a standard deviation of the normal distribution multiplied by the standard deviation multiple while retaining a remaining portion of the plurality of random values;
wherein generating the random value satisfying the confidence constraint comprises selecting the random value from the remaining portion.
